(19) United States
(12) Patent Application Publication
(10) Pub. No.: US 2008/0272513 A1
(43) Pub. Date: Nov. 6, 2008

(54) Process for the Coextrusion of Melt Streams of Different Composition

(76) Inventor: Holger Stenzel, Hennef (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/593,060

(22) PCT Filed: Mar. 16, 2005
(86) PCT No.: PCT/EP2005/051212

§ 371 Date: Jul. 23, 2008

(30) Foreign Application Priority Data
Mar. 17, 2004 (DE) 10 2004 013 201.1

(51) Int. Cl. B29C 47/06

(52) U.S. Cl. 264/173.17; 264/173.16; 264/173.18

(57) ABSTRACT

The invention relates to a method for coextrusion of at least two molten material flows having different composition by separating the molten material into at least two molten material flows, admixing additives in at least one of the molten material flows and bringing together the molten material flows by coextrusion in one or more extrusion tools. The method is particularly suitable for the production of PVB films with a color strip for composite glazings.

### TECHNICAL FIELD

The invention relates to a process for the coextrusion of at least two streams of polymer melts of different composition and/or to a process for the extrusion of an intermediate layer exhibiting a tinted strip for composite glazing.

Articles made of plastic are frequently produced by coextruding polymer melts of different composition. Thus, a coextrusion of at least two polymer streams with different colours is carried out e.g. for the production of plastic films with differently tinted areas.

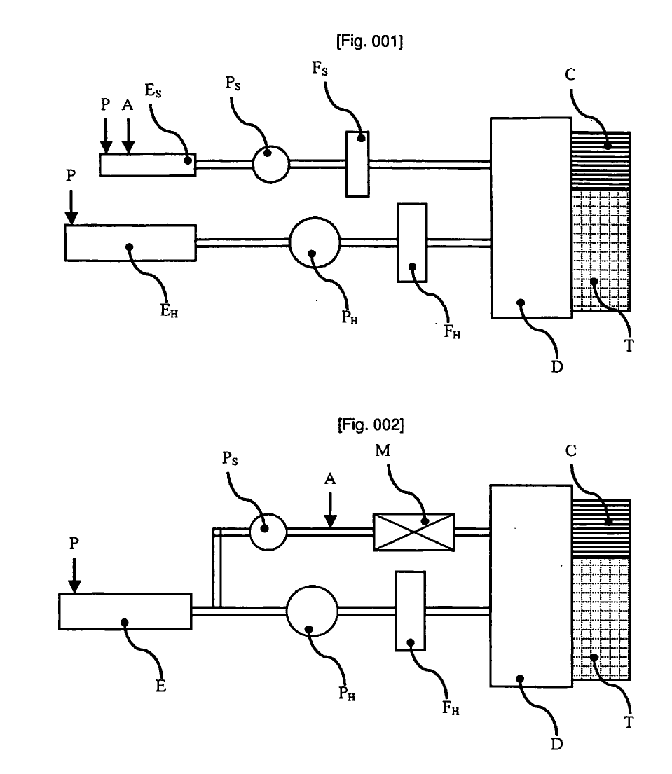

When making PVB films with a tinted strip for vehicle windscreens, a colourless main stream is combined with a tinted subsidiary stream in an extrusion die such that the two streams melt together and a film with two differently tinted areas and a gradual colour transition is formed. FIG. 1 shows a diagrammatic representation of such a coextrusion facility. Here, a plasticizer-containing polymer mass P is passed in the main stream respectively through the main extruder E_{H} and in the subsidiary stream through the subsidiary extruder E_{S} via melt pumps P_{H/S} and melt filters F_{H/S} into the extrusion die D. The addition of the dye A takes place with polymer mass P in the subsidiary extruder E_{S}. In the die D, the actual coextrusion is carried out giving the film T with a tinted strip C. In order to obtain a uniform width of the tinted strip, the conveying performance and pressures of the extruders and melt pumps must be satisfactorily matched.

Coextrusion processes with main and subsidiary extruders are the subject matter of numerous patents such as e.g. EP 0 111 678 B1, U.S. Pat. No. 4,316,868, U.S. Pat. No. 4,476,075 or GB 1 323 763. In these processes, the dyes or colour pigments are dissolved or dispersed in the plasticizer which is used in any case and subsequently metered into the subsidiary extruder (E_{S}) together with the PVB resin. Alternatively, the tinted plasticizer can also be premixed with PVB resin and subsequently metered as tinted blend into the subsidiary extruder E_{S}. In the latter, melting and homogenising of the mixture as well as discharge of the tinted melt into the extrusion die take place.

However, this process has the disadvantage that, besides the main strand, a complete second extrusion strand with plasticizer processing, gravimetric metering of the components, extruder, melt pump and melt filter is required. The investment in such equipment can amount to 1-2 million Euros, depending on the size of the facility. An additional disadvantage is that the change-over in film production from one colour to another or from coloured to transparent requires a fairly long time for flushing dye residues from the facility. The film produced during this period frequently still exhibits colour inhomogeneities and can consequently no longer be used for laminated glazing.

Moreover, dyes and coloured pigments may be subject to production variations such that even in the same recipes slightly differently tinted products may be obtained. However, tint aberrations can be detected only in the finished extruded film such that film not satisfying the specifications needs to be disposed of in a cost-intensive manner. However, these processes do not relate to non-transparent polymers whose optical properties need to satisfy only low requirements (in respect of which only low requirements are made?). The production of transparent polymers in an optical quality, e.g. for glazing, cannot be found in these publications.

For the production of polymer films, processes are known in the case of which polymer melts are divided into a main and a subsidiary stream and—after the addition of additives for moulding—are recombined (U.S. Pat. No. 4,919,864; U.S. Pat. No. 5,190,766). Similarly, the division of polymer melts for separate tinting and subsequent coextrusion is known for extrusion (DE 2835139).

### TECHNICAL TASK

The task of the present invention consequently consisted of developing a process for the coextrusion of polymer melt streams of different composition which does not exhibit the disadvantages of the state of the art described above. In particular, the change-over periods for additives should be reduced and production failures more rapidly recognised and remedied on the basis of inhomogeneities of the coextrudate.

### DISCLOSURE OF THE INVENTION

The subject matter of the present invention consequently consists of a process for the coextrusion of at least two polymer melt streams of different composition characterised by the process steps of

a) melting of a polymer mass
b) separating the melt into at least two melt streams
c) mixing of additives into at least one melt stream and
d) combining the melt streams with coextrusion in one or several extrusion dies, the polymer mass being based on polyvinyl butyral, ethylene vinyl acetate, polyvinyl alcohol and/or a terpolymer with ethylene units, vinyl acetate units and vinyl alcohol units.

By means of the process according to the invention, polymer melt streams containing preferably the same polymer and/or polymer mass but different additives can be coextruded in a manner flexible from the point of view of an industrial-scale production. The procedure according to the invention provides additionally the advantage of being able to do without a not inconsiderable part of the investments for the extrusion strand to which the additives are admixed.

The polymer mass used in the process according to the invention is based on polyvinyl butyral (PVB), ethylene vinyl acetate (EVA), polyvinyl alcohol (PVA) and/or a terpolymer of ethylene units, vinyl acetate units and vinyl alcohol units, i.e. it contains these polymers in a quantity of at least 60, 70, 80, 90, 95 or 100% by weight, based on the polymer mass used in step a). These polymers can be used as such, as a blend and/or in mixture with plasticizers and/or fillers and/or other additives.

The polyvinyl butyrals used can have a degree of acetylation of 50-95%, preferably 65-85% and a residual PVOH content of 25-5%. The polyvinyl alcohols have, in particular, a degree of hydrolysis of 75-100%, corresponding to an acetate content of approximately 25-0%.

The terpolymer with ethylene units, vinyl alcohol units and vinyl acetate units possesses these substructures preferably in the proportions of 0.5-20 mole %, 80-95.5 mole % and 10-0.5 mole % respectively.

Different polymer masses and/or melt streams according to the meaning of the present invention may contain e.g. the same polymers but different proportions of plasticizers, fillers or additives.

The above-mentioned polymers, blends, mixtures or organic or inorganic pigments, carbon black, silicic acid, UV stabilizers and/or titanium dioxide can be used as additives for process step c). For the production of PVB films for composite glazing, phthalocyanines or their metal complexes have proved suitable as dye.

The process according to the invention can be used in particular for the production of films or sheets exhibiting at least two areas of different colour intensity. In this case, at least two melt streams of different colour are extruded in process step d).

Particularly advantageously, the process according to the invention is used for the production of a film suitable as intermediate layer in composite glazing and exhibiting a tinted strip. In this case, a PVB containing polymer mass, i.e. a mass containing PVB, plasticizer, adhesion regulator and, if necessary, further additives, are melted in an extruder and divided into a main and a subsidiary stream. Dyes such as pigments are added to the subsidiary stream; subsequently, both streams are coextruded to form a film exhibiting a tinted strip.

During the production of plasticizer-containing PVB films for laminated glazing, polymer mixtures, e.g. according to DE 101 62 338 A1 or WO 02/102591 A1 can be used. These consist in a proportion of approximately 70-75% by weight of PVB with a PVOH content of approximately 20% and in a proportion of 30-25% by weight of plasticizer such as 3G8. Additional components are anti-blocking agents, surfactants, adhesion regulators, UV stabilisers and antioxidants.

For the manufacture of a film for laminated glazing of polyvinyl butyral (PVB) with a tinted band, the process according to the invention can be carried out e.g. according to FIG. 2 the polymer mass P of PVB, plasticizer and UV stabiliser etc is melted in the extruder E. A defined partial stream of the transparent melt strand obtained is passed, before entry into the extrusion die D, via a melt valve (not illustrated) into a subsidiary strand. There, the coloured pigments and/or other additives A are metered in and admixed via a static or dynamic mixer M homogeneously into the melt stream. Subsequently, the transparent main stream and the additive-containing subsidiary stream are sprayed, as described e.g. in EP 111 678 B1, into the die D and discharged as coextrusion layer (film) T. The pressure necessary to overcome the die resistance and the pressure loss of the mixer M is applied via melt pumps P_{S} and P_{H}. Optionally, the main strand can be passed through the melt filter F_{H}.

In order to be able to meter additives in powder form such as dyes or pigments with a satisfactory accuracy into the melt streams, these additives may previously be made into a paste. This means that they are incorporated into a liquid compatible with the melt and additive such that a paste with a preferably honey type viscosity is formed. Suitable liquids are substances already present in the melt and/or to be added in any case such as e.g. plasticizers. So that the difference in the liquid content (plasticizer content) between the different melt streams should not become too great, the additive paste should have a relatively high concentration. This means in turn that the quantity of paste metered in, in relation to the melt stream, is very small, leading to high requirements regarding the precision of the metering device. Consequently, the additive concentration of the paste must not be selected too high, in particular as non-flowing materials can be metered only with great difficulty. In practice, the use of a 10-15% paste (i.e. 100-150 g of additive are present in 1 kg of paste) has proved suitable. This may lead to a difference in the liquid or plasticizer content between the melt streams (subsidiary strand and main strand) of between 0.2 and 0.5 percentage points. If the main strand contains e.g. 27% plasticizer, 27.2-27.5% of plasticizer are present in the melt after the addition of a 10-15% additive paste. These differences are tolerable with respect to the viscosity differences resulting therefrom during subsequent coextrusion.

Preferably, melting of the polymer mass in process step a) is carried out in one or several extruders, particularly preferably in a single extruder. If the polymer mass used is a mixture of several components, e.g. a mixture of PVB resin, one or several plasticizers, adhesion regulators and UV stabilisers, mixing of these components appropriately takes place also in the extruder of process step a).

In process step b), the melt obtained from a) is divided by means of suitable valves into at least two (preferably two, three or four) melt streams.

At least one of the melt streams can be passed before and/or after the corresponding process step c) through a dynamic or static mixing section. To avoid inhomogeneities which may still be present from process step b), the use of such a mixing section is to be recommended also before the addition of additives according to process step c).

The mixing sections used according to the invention can be static (i.e. immovable) or dynamic (i.e. rotating) mixers. In the case of static mixers, connectors are introduced into the melt channel in such a way that several open, crossing stream channels are formed by means of which a melt stream is continually mixed by continuous division, expansion and rearrangement over the entire cross-section of the stream. The mixing energy is applied by melt pumps or extruders. The length of the mixing section determines the mixing quality. Further dimensional values are the viscosity, density and temperature of the materials to be mixed as well as the stream cross-section and the mass flow rate.

Since mixers change the flow profile of the melt stream concerned from a parabolic to an almost rectangular form, it is appropriate not to use any free melt channels without mixing elements from the additive input site onwards in order to keep the times for colour change and purification as short as possible. Mixers can have a modular structure, i.e. be built up of several segments and also be integrated into curved melt channels such that it is possible to largely avoid a parabolic stream of the melt.

A further possibility of admixing additives in process step c) is provided by the use of a dynamic mixer such that process step c) of at least one melt stream can be carried out in a dynamic mixer. In this case, a planet wheel pump from Barmag AG, type Promix AC, is suitable for use as dynamic mixing element. Pumps of this type have one or several inlet and discharge apertures, the driven centrally arranged planet wheel being connected on the melt inlet side with a melt mixer. This dynamic mixer has cavities in the stator (pump housing) and in the rotor (pump shaft), resulting in a three dimensional stream. Apart from dispersive mixing, intensive distributive mixing also takes place in dynamic mixing systems. The advantage of the pump mixer is that the pressure loss of the mixer is compensated by the gear wheel pump. Feeding in of the additives such as the dye paste into the melt stream preferably takes place in the inlet channel of the mixer such that the melt line passing from the extruder to the pump is not filled with additives and/or dye. In the case of colour changes, the lines to the mixer do not need to be flushed out for this reason. Compared with a static mixer, the mixing length is considerably shorter in the case of the dynamic mixer. Basically, the sequence of pump and mixer can also be reversed such that dye metering then takes place between the pump and the mixer.

Corresponding melt filters can be used to filter the melt streams, which filters can be arranged in various ways. It is thus possible for the melt to be passed through a melt filter between process step a) and b). As an alternative, at least one melt stream can be passed through a melt filter after process step b) before and/or after the corresponding process step c).

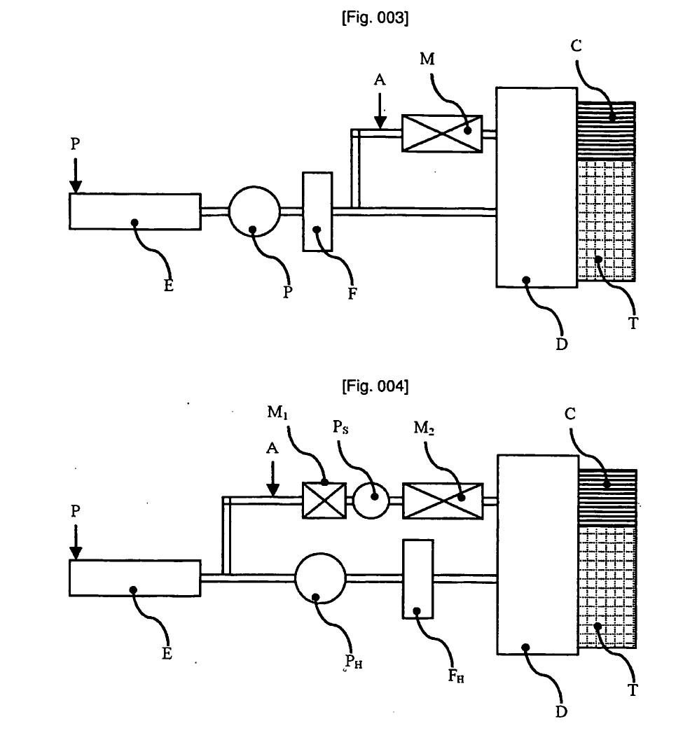

The simplest embodiment of the present invention is illustrated in FIG. 3. In this case, the polymer melt is produced in extruder E, passed by means of a pump P through an optional melt filter F and divided into a main and a subsidiary strand. The additives A are metered into the subsidiary strand and the melt stream thus obtained is homogenised in mixing section M. The two strands/polymer streams are combined in die D and coextruded to form film T with an additive-containing area C.

As illustrated in FIG. 2, two melt pumps are preferably used in order to be able to adjust the flow rates for the individual melt streams independently of each other and to overcome the resistance of the pressure consumers present behind the pumps such as static mixer, melt filter or extrusion die. The question then arises as to the best site regarding the interaction with the mixer and the additive introduction for the pump of the individual melt streams to be incorporated. Basically, there are three possibilities:

1. between the extruder and the additive input
2. between the additive input and the mixer
3. between the mixer and the extrusion die (extruder)

Variation 1 provides the advantage of being able to meter in the additives directly in front of the static mixer. As a result, it impinges immediately on the mixing elements and can thus be homogenised satisfactorily. The disadvantage of this variant is that the additives need to be injected against a high pressure (of up to 200 bar) since both the extrusion die and the static mixer act as pressure consumers. In the case of small metered quantities of additives, this may lead to problems regarding the metering accuracy if the counter-pressure becomes too high. If necessary, this can be avoided by using a special metering pump from Barmag AG. Such a pump consists of two gear wheel pumps connected in series. The first gear wheel pump serves the purpose of building up pressure, the second pump provides accurate metering. The device is adjusted via a spring mechanism such that the pressure difference is zero across the second pump and consequently no leakage streams are formed between the pressure and the suction side.

Variation 2 circumvents the problem of the high injection pressure since the additive input takes place before the pressure increasing pump and is thus injected only against a low pressure (<30 bar). However, there is the risk of additives depositing in dead zones of the pump.

The advantage of variation 3 consists of a very precise melt dosage since the pressure increasing pump is situated directly in front of the extrusion die. However, in this case, too, the additives need to be metered in against a relatively high pressure which is generated by the static mixer. The pressure loss of the mixer must, in this case, be compensated by the extruder, increasing the shear stress of the melt in the extruder and causing the temperature of the mass to rise.

In an optimised variation of the process according to the invention, which is outlined in FIG. 4, the additives are metered in in front of the melt pump Pₛ. After metering in, a brief intensive mixing takes place in a static mixer M₁ before the previously homogenised melt passes into pump Pₛ. A fairly long mixing zone M₂ for final homogenisation follows, the mixing section optionally extending from the pump up to the extrusion die. In the case of this variation of the process according to the invention, the additive injection can take place at relatively low pressures without the risk of additive depositing in the pump.

When a dynamic mixer is used, this is appropriately employed immediately before the extrusion die. In this case, too, the additives such as dye can be injected against relatively low pressures. The incorporation of the dynamic mixer immediately in front of the die moreover provides the advantage of being able to keep the melt section contaminated with additive very small leading to extremely short additive change-over times.

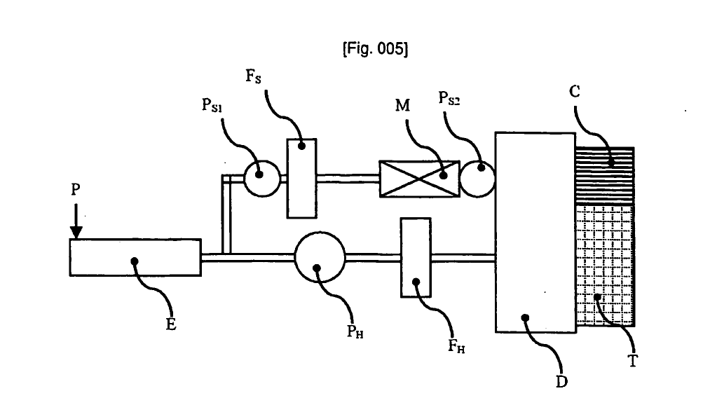

In FIG. 5, such a process variation is outlined. In this case, a polymer mass P is melted in extruder E and subsequently divided into two melt streams. In the main stream, the pressure loss of the optional filter F_{H} and the extrusion die D are balanced by the melt pump P_{H}. For the case of an optional melt purification carried out in filter F_{H}, the subsidiary stream is equipped with an equally optional pump P_{S1}. The additive A is fed in shortly before or directly into the dynamic mixer M, the mixer exhibiting an additional pump P_{S2}. The streams are combined in die D and coextruded to form a film T with an additive-containing area C.

In the process according to the invention, at least one melt stream in process step d) is preferably extruded through an extrusion die which a wedge-shaped or torpedo-shaped partial area.

The polymer mass may contain one or several plasticizers. Current plasticizers for the above-mentioned polymers are e.g. glycerine, ethylene glycol, diethylene glycol, triethylene glycol, trimethylol propane, neopentyl glycol, triethylamine, poly(ethylene) glycols, poly(ethylene oxides) including block copolymers of type HO—(CH2-CH2-O)ₙ—(CH2-CH(CH3)-O)m-H with n>2, m>3, n/m>0.3 and (n+m)<25 or poly(butylene oxides) as well as their derivatives. In the case of these, at least one of the two terminal hydroxyl groups of the poly(ethylene oxides) or poly(butylene oxides) is replaced by an organic radical. Examples of these are e.g. ethoxylated fatty alcohols, ethoxylated fatty acids such as oleic acid polyethylene glycol ester or monoether of polyalkylene glycol with simple aliphatic alcohols such as methanol or ethanol.

In addition, plasticizers of the following groups can be used:
Esters of multivalent aliphatic or aromatic acids, e.g. dialkyl adipates such as dihexyl adipate, dioctyl adipate, hexyl cyclohexyl adipate, mixtures of heptyl and nonyl adipates, diisononyl adipate, heptyl nonyl adipate as well as esters of adipic acid with cycloaliphatic ester alcohols, dialkyl sebacates such as dibutyl sebacate, phthalate esters such as butyl benzyl phthalate;
Esters of polyhydric aliphatic or aromatic alcohols or oligoether glycols with a maximum of four ethylene glycol units with one or several unbranched or branched aliphatic or aromatic substituents, e.g. esters of diglycols, triglycols or tetraglycols with linear or branched aliphatic or cycloaliphatic carboxylic acids; examples of the latter group may be diethylene glycol bis-(2-ethyl hexanoate) (3G8), triethylene glycol bis-(2-ethyl hexanoate), triethylene glycol bis-(2-ethyl butanolate), tetraethylene glycol bis-n-heptanoate, triethylene glycol bis-n-heptanoate, triethylene glycol bis-n-hexanoate.

1. A process for coextrusion of at least two polymer melt streams of different composition, said process comprising
a) melting of a polymer mass
b) separating the melt into at least two melt streams
c) mixing of additives into at least one melt stream and
d) combining the melt streams with coextrusion in one or several extrusion dies, the polymer mass being based on polyvinyl butyral, ethylene vinyl acetate, polyvinyl alcohol and/or a terpolymer with ethylene units, vinyl acetate units and vinyl alcohol units.

2. A process according to claim 1, wherein at least one melt stream is passed through a dynamic or static mixing section before and/or after process step c).

3. A process according to claim 1, wherein process step c) takes place in a dynamic mixer.

4. A process according to claim 1, wherein the melt is passed through a melt filter between process step a) and b).

5. A process according to claim 1, wherein, after process step b), at least one melt stream is passed through a melt filter before and/or after the corresponding process step c).

6. A process according claim 1, wherein at least one melt stream is extruded in process step d) through an extrusion die with a wedge-shaped or torpedo-shaped partial area.

7. A process according to claim 1, wherein the additive in process step c) contains organic or inorganic pigments, carbon black, silicic acid, UV stabilisers and/or titanium dioxide.

8. A process according to claim 1, wherein the additive in process step c) contains PVB, EVA, PVC, PE, PP, PS, PC, PA and/or PMMA as such or as a blend and/or in mixture with plasticizers and/or fillers.

9. A process according claim 1, wherein in process step d) at least two melt streams of a different colour are extruded to form a film or sheet with at least two areas of different colour intensity.

10. A process for the production of a film exhibiting a tinted strip and suitable for use as intermediate layer in laminated glazing characterised in that, in a process according to claims 1 to 9, a mass containing polyvinyl butyral is melted, divided into a main stream and a subsidiary stream, pigments are added to the subsidiary stream and the two streams are coextruded to form a film exhibiting a tinted strip.

11. A process according to claim 1, wherein said polymer mass is based on polyvinyl butyral or a terpolymer with ethylene units, vinyl acetate units and vinyl alcohol units.
